(19) United States
(12) Patent Application Publication
(10) Pub. No.: US 2022/0178469 A1
(43) Pub. Date: Jun. 9, 2022

(54) TECHNIQUES FOR DETERMINING VALVE STATE AND MATERIAL PRESENCE/ABSENCE UTILIZING NON-CONTACT ACOUSTICS

(71) Applicant: PERCEPTIVE SENSOR TECHNOLOGIES, INC., Tucson, AZ (US)

(72) Inventors: JOEL D. BURCHAM, HUNTSVILLE, AL (US); EARL CROCHET, HUMBLE, TX (US); LAZAR BIVOLARSKY, CUPERTINO, CA (US); JAMES M. HEIM, TUCSON, AZ (US)

(21) Appl. No.: 17/542,814

(22) Filed: Dec. 6, 2021

Related U.S. Application Data
(60) Provisional application No. 63/121,546, filed on Dec. 4, 2020.

(51) Int. Cl. F16K 37/00; G01F 1/66

(52) U.S. Cl. CPC F16K 37/0083; G01F 1/66

(57) ABSTRACT

Systems, methods, and related devices are disclosed for determining a valve state and/or determining the presence of a material within a vessel. A vessel is holding or transporting a quantity of material. At least one valve is positioned within the vessel, the at least one valve controlling at least a portion of a flow of the quantity of material. At least one acoustic sensor is positioned on an exterior of the vessel. At least one computing device is in communication with the at least one acoustic sensor. A processor of the at least one computing device determines a flow rate of the quantity of material based on at least one acoustic signal transmitted from the at least one acoustic sensor. The processor determines a state of the at least one valve based, at least in part, on the determined flow rate of the quantity of material.

### CROSS REFERENCE TO RELATED APPLICATION

This application claims benefit of U.S. Provisional Application Ser. No. 63/121,546 entitled, “Techniques for determining valve state and material presence/absence utilizing non-contact acoustics” filed Dec. 4, 2020, the entire disclosure of which is incorporated herein by reference.

### FIELD OF THE DISCLOSURE

The present disclosure relates to acoustic sensors and, more particularly, to use of acoustic sensors in relation to material flows in vessels.

### BACKGROUND OF THE DISCLOSURE

Numerous industries use valves and valve mechanism to control the flow of fluid and gases. Valves come in a variety of types and sizes and serve a variety of purposes, such as flow control, relief, sampling, and pressure reduction, among others. Within commercial or industrial settings, over time, valve mechanisms can become clogged, stuck, or otherwise difficult to actuate, making them difficult to move between opened and closed positions. This degradation of the valves may be due, for example, to a buildup of the material being transported through the vessel or pipe in which the valve is installed. For example, in the petroleum industry, over time, valves may become clogged or degraded from the build up of sludge, particulate, waxes, and other substances which may be within the petroleum product flowing through the valve.

In the field, workers typically have little to no information on whether and how well a valve might be open or closed. Consequently, workers often go to significant lengths to ensure that a given valve is sufficiently open or closed. For instance, it is commonplace to use an improvised breaker bar (sometimes known as a “cheater bar”) to exert a strong mechanical force on the valve to thereby power the valve to an opened state or a closed state. However, application of excessive force via such means may damage the valve, shortening its overall lifespan and effectively making the work environment more difficult, and perhaps hazardous, for workers. When a valve cannot be closed or opened fully, or to the desired level, the result may be an inadvertent leakage or an inadvertent reduced flow, respectively, through the vessel or pipeline in which the valve is located, which is undesirable.

Thus, a heretofore unaddressed need exists in the industry to address the aforementioned deficiencies and inadequacies.

### SUMMARY OF THE DISCLOSURE

Embodiments of the present disclosure provide a system and method for determining a valve state. Briefly described, in architecture, one embodiment of the system, among others, can be implemented as follows. A vessel is holding or transporting a quantity of material. At least one valve is positioned within the vessel, the at least one valve controlling at least a portion of a flow of the quantity of material. At least one acoustic sensor is positioned on an exterior of the vessel. At least one computing device is in communication with the at least one acoustic sensor. A processor of the at least one computing device determines a flow rate of the quantity of material based on at least one acoustic signal transmitted from the at least one acoustic sensor. The processor determines a state of the at least one valve based, at least in part, on the determined flow rate of the quantity of material.

The present disclosure can also be viewed as providing a system for determining a presence of a material within a vessel. Briefly described, in architecture, one embodiment of the system, among others, can be implemented as follows. A vessel is capable of holding or transporting a quantity of material. At least one valve is positioned within the vessel. The at least one valve controls at least a portion of a flow of the quantity of material. At least one acoustic sensor is positioned on an exterior of the vessel at a position on an underside of the vessel. At least one computing device is in communication with the at least one acoustic sensor, wherein a processor of the at least one computing device determines a density of any material positioned within the vessel in a location above the at least one acoustic sensor, and wherein the processor determines a presence of material within the vessel based on, at least in part, the determined density of the quantity of material.

The present disclosure can also be viewed as providing methods of determining a valve state. In this regard, one embodiment of such a method, among others, can be broadly summarized by the following steps: providing a vessel holding or transporting a quantity of material, the vessel having at least one valve positioned at least partially therein; controlling at least a portion of a flow of the quantity of material with the at least one valve; positioning at least one acoustic sensor on an exterior of the vessel; using at least one computing device in communication with the at least one acoustic sensor, the at least one computing device having a processor, determining a flow rate of the quantity of material based on at least one acoustic signal transmitted from the at least one acoustic sensor; and determining a state of the at least one valve based, at least in part, on the determined flow rate of the quantity of material.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is a diagrammatical illustration of a system for determining the state of a valve associated with a vessel, in accordance with a first exemplary embodiment of the present disclosure.

FIG. 2 is a diagrammatical illustration of a system for determining the presence of a material in a vessel, in accordance with the first exemplary embodiment of the present disclosure.

FIG. 3 is a diagrammatical illustration of the system for determining the presence of a material in a vessel of FIG. 2, in accordance with the first exemplary embodiment of the present disclosure.

FIG. 4 is a diagrammatical illustration of the system for determining the presence of a material in a vessel of FIG. 2, in accordance with the first exemplary embodiment of the present disclosure.

FIG. 5 is a flowchart illustrating a method of determining the state of a valve within a vessel, in accordance with the first exemplary embodiment of the present disclosure.

### DETAILED DESCRIPTION

To improve over the shortcomings identified previously, techniques for determining valve state and material presence/absence utilizing non-contact acoustics are disclosed. In accordance with some embodiments, one or more acoustic sensors may be disposed proximate an exterior of a vessel, downstream of a valve. A given acoustic sensor may be configured, to detect a flow of material within the vessel, and such data may be utilized, for example, in determining whether the upstream valve is open, closed, or leaking. In accordance with some embodiments, a given acoustic sensor may be configured to detect local densities, and such data may be utilized, for example, in determining whether a material is locally present in the vessel. In accordance with some embodiments, techniques disclosed herein may be utilized, for example, in relation to liquid and/or gaseous materials. In accordance with some embodiments, techniques disclosed herein may be utilized separately or in conjunction with one another, as desired for a given target application or end-use. Numerous configurations and variations will be apparent in light of this disclosure.

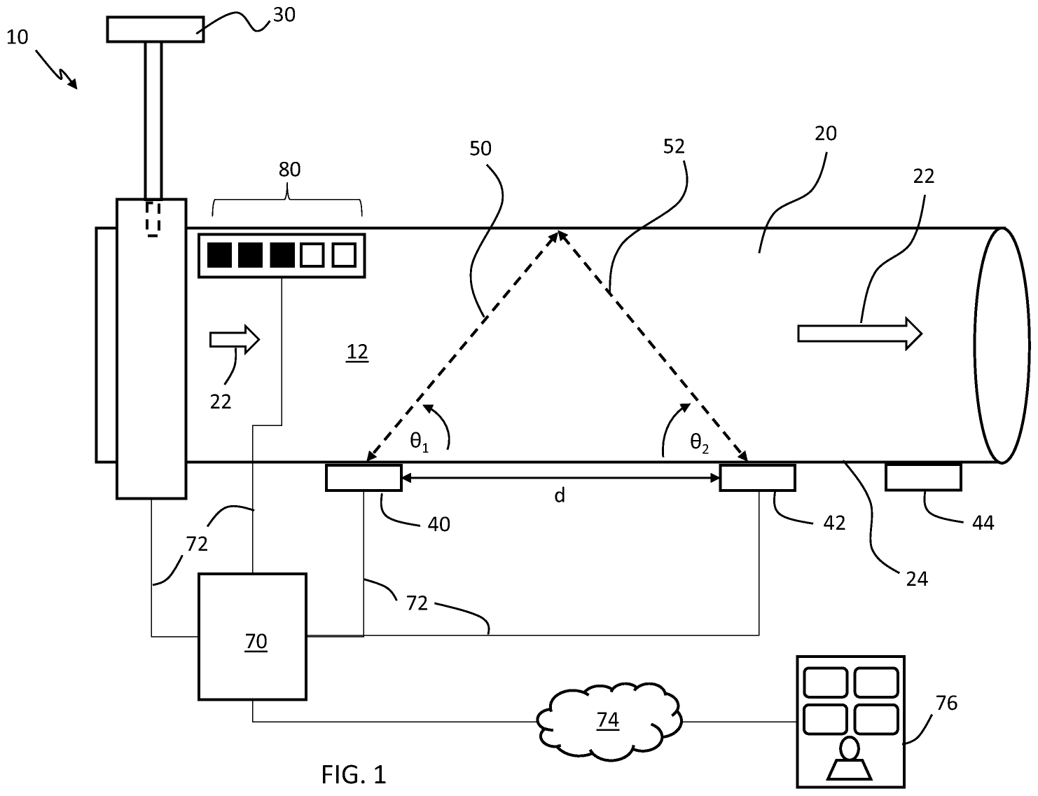

FIG. 1 is a diagrammatical illustration of a system for determining the state of a valve associated with a vessel 20, in accordance with a first exemplary embodiment of the present disclosure. The system for determining the state of a valve associated with a vessel 20, which may be referred to simply as ‘system 10’ includes a vessel 20 holding or transporting a quantity of material 12 therein. The vessel 20 may include any type of container, storage unit, or other structure capable of holding or transporting material, often a liquid, fluid, or gas. For instance, the vessel 20 may include a storage container or tank, a pipe, a pipeline, a hose, a conduit, a channel, or a similar structure. In some cases, vessel 20 may be, or include a tank, container, or other receptacle for hosting a volume of material. The material 12 may include any type of material but is preferably a gas and/or liquid material. As shown in FIG. 1, the material 12 may be moving through the vessel 20 in the direction indicated by arrows 22.

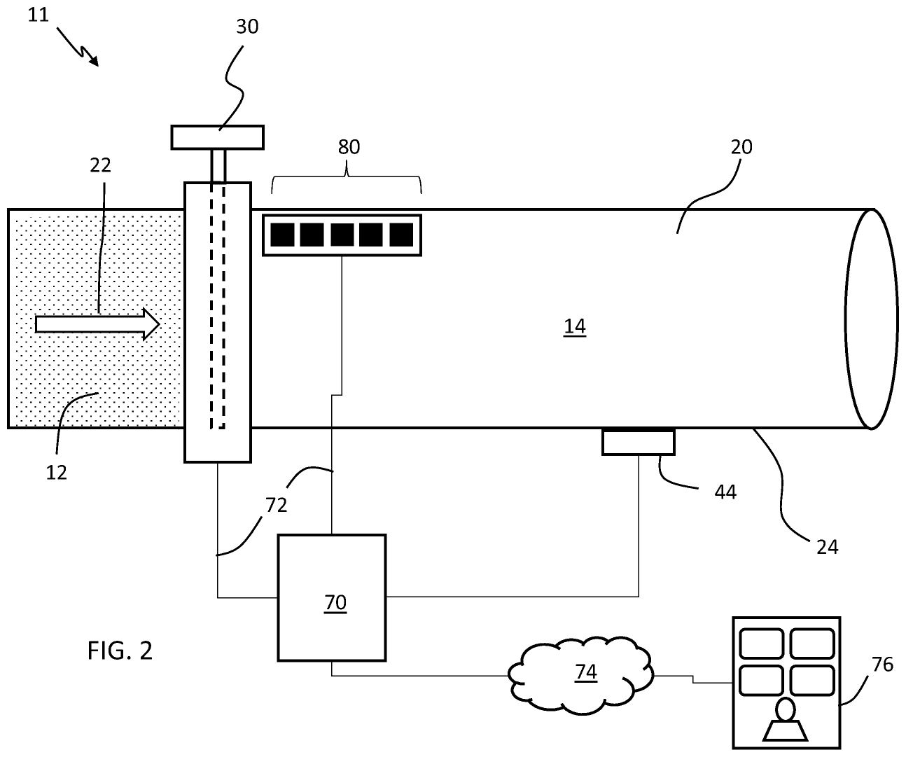

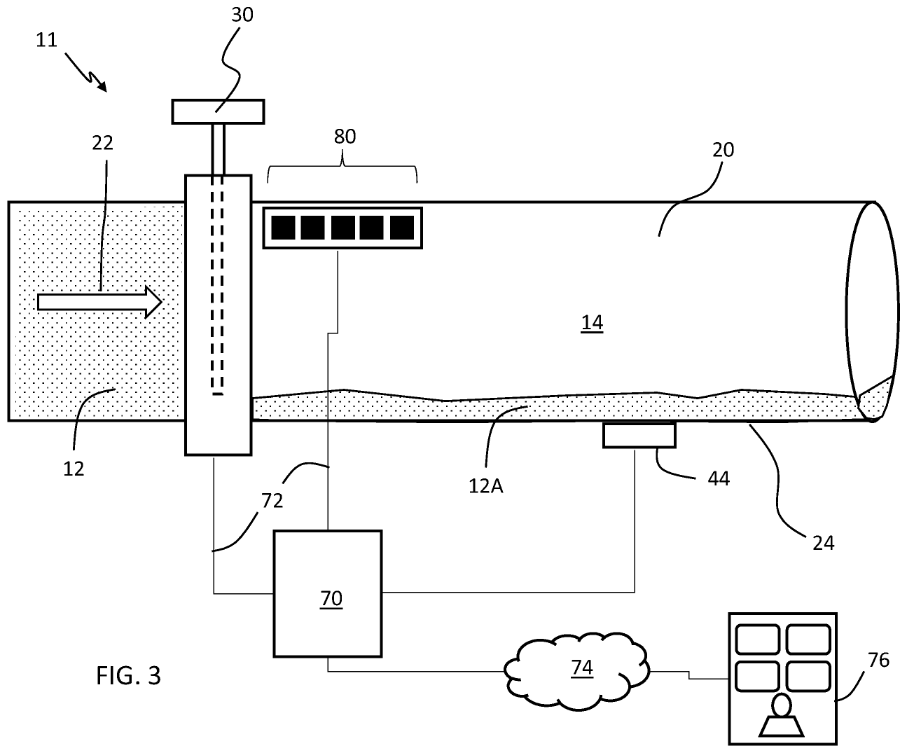

At least one valve 30 may be positioned within the vessel 20, which may include a valve 30 being fully or partially positioned within the vessel 20 or otherwise associated with the vessel 20 in such a way that the valve 30 is capable of controlling a flow of material 12 through at least part of the vessel. The valve 30 may be any of a wide range of valve devices, such as, for example, a ball valve, a butterfly valve, a globe valve, a needle valve, or a pinch valve, among other valve structures known in the art. The valve 30 may be located across all or part of a flow path of the material 12, as may vary based on the design of the vessel 20. In FIG. 1, the valve 30 is simplistically illustrated as being positioned across the entirety of the flow path of the material 12 through the vessel 20, and with the valve 30 in an open position, as indicated by the raised valve stem. In comparison, the valve in FIGS. 2-3 is shown in the fully or partially closed position, as indicated by the lowered valve stem.

At least one acoustic sensor is positioned on an exterior of the vessel 20. In FIG. 1, a plurality of acoustic sensors is positioned on the exterior of the vessel 20, including first acoustic sensor 40, second acoustic sensor 42, and a third acoustic sensor 44. More specifically, the first acoustic sensor 40 may be disposed proximate the exterior of vessel 20, downstream of valve 30, such as by having the first acoustic sensor 40 mounted directly or indirectly, e.g., with one or more intervening layers, to an exterior surface 24 of vessel 20. The first acoustic sensor 40 may be configured to transmit one or more acoustic signals 50 into vessel 20, for instance, at an angle θ₁ with the flow of the material 12 in vessel 20. The angle θ₁ may be greater than 0°, e.g., horizontal or parallel with the flow direction 22, and less than 90°, e.g., vertical or perpendicular to the flow direction 22. As will be appreciated, in some cases, the acoustic signal 50 transmitted by first acoustic sensor 40 may reflect off interior surface of vessel 20 one or more times. The first acoustic sensor 40 and/or second acoustic sensor 42, discussed further below, may receive the acoustic signal 50 transmitted by first acoustic sensor 40. The time elapsed from transmission of acoustic signal 50 to receipt thereof by a given acoustic sensor 40, 42, etc., after the acoustic signal 50 have passed through the material 12 in vessel 20 may be considered a first time-of-flight (ToF₁) through the material 12.

As can be seen further from FIG. 1, the second acoustic sensor 42 may be disposed proximate the exterior surface 24 of vessel 20, downstream of valve 30. More specifically, the second acoustic sensor 42 may be mounted directly or indirectly, e.g., with one or more intervening layers, to the exterior surface 24 of vessel 20. The second acoustic sensor 42 may be configured to transmit one or more acoustic signals 52 into vessel 20, for instance, at an angle θ₂ against the flow direction 22 of the material 12 in the vessel 20. The angle θ₂ may be greater than 0°, e.g., horizontal or parallel with the flow direction 22, and less than 90°, e.g., vertical or perpendicular to the flow direction 22. In some cases, the acoustic signal 52 transmitted by second acoustic sensor 42 may reflect off an interior surface of the vessel 20 one or more times, though such is not required. The second acoustic sensor 42 and/or first acoustic sensor 40 may receive the acoustic signal(s) 52 transmitted by second acoustic sensor 42. The time elapsed from transmission of acoustic signal 52 to receipt thereof by a given acoustic sensor 40, 42 after the acoustic signal 52 has passed through the material in vessel 20 may be considered a second time-of-flight (ToF₂) through the material 12. The third acoustic sensor 44 may be used to determine a density of the material 12, which may or may not be used with determining the state of the valve 30.

The system further includes at least one computing device 70 in communication with the acoustic sensors 40, 42, etc., wherein a processor of the computing device 70 is capable of making calculations to determine various properties. For example, the computing device 70 may have network connections 72 with the acoustic sensors 40, 42, etc., the valve 30, and/or other components of the system 10, such that it can receive signal data and other data from these devices. In one example, the computing device 70 determines a flow rate of the material 12 based on an acoustic signal transmitted from one or more acoustic sensors, 40, 42, 44, etc., and using this signal data or other data, the processor of the computing device may determine a state of the valve 30 based, at least in part, on the determined flow rate of the material 12. For example, this state may be one of an opened state, a closed state, a partially opened state, or a partially closed state, among others.

In further detail, the bulk flow rate of the material 12 flowing within vessel 20 may be calculated by dividing the differential ToF by the path length of the acoustic signals 50, 52. The differential ToF may be calculated by taking the difference between the first and second ToF measurements (ToF₁, ToF₂). The path length of the acoustic signals 50, 52 may be the distance ‘d’ separating first and second acoustic sensors 40, 42, or another known distance. The output of acoustic sensors 40, 42 may be provided to the processor of the computing device, such that the processor may calculate the flow velocity (v) of the material 12 within vessel 20. The flow velocity (v) calculation generally may be indicative of the state of valve 30. For instance, a flow velocity (v) of zero may be indicative of valve 30 being in a fully closed state, whereas a non-zero flow velocity (v) generally may be indicative of valve 30 being in an open state, either a fully opened state or a partially opened state. If valve 30 is considered to be fully closed but a non-zero flow velocity is obtained, then such result generally may be indicative of a leaky valve 30.

The computing device 70 and network connections 72 within FIG. 1 may have various features, designs, or architectures. For example, the network connection 72 may include any suitable network systems, including wired data connections and wireless data connections, e.g., LAN, intranet, Internet, Wi-Fi®, Bluetooth®, NFC, radio, or any other type of network connection. The computing device 70 may include any type and number of processors, including stationary processors, mobile processors, mobile devices, processor arrays, cloud processing networks, and the like. The computing device 70 may include any components required for operation, including a power source, computer-readable memory, network communications, and the like.

Data from the acoustic sensors 40, 42, etc. may be communicated to the computing device 70 along the network connections 72, or by other means. Communicated data may include data from the acoustic sensors 40, 42, 44, etc., such as characteristic information about any acoustic signals transmitted, and received data from any reflected acoustic signals received by the acoustic sensors 40, 42, 44, etc. Communicated data may further include data from the additional acoustic sensors, if present, the valve 30, or other sensors or components, such as temperature sensors. The communicated data may be analyzed by the processor of the computing device 70 or other computing devices.

As will be appreciated in light of this disclosure, data pertaining to the state of valve 30 may be presented for user review, or for another purpose, in any of a wide range of manners. Generally, the specific form of data presentation regarding the state of valve 30 may be customized, as desired for a given target application or end-use. In some cases, the form of data presentation may depend on the type of valve 30, control needs, and/or user preferences, among other factors. In one example, the data may be communicated through a cloud network 74 to one or more remotely-located computing systems, such as those within a control room 76, to dashboards or interfaces accessible through the Internet, or elsewhere.

The data pertaining to the state of the valve may also be converted or calculated to be within one of various formats which may allow an end user to better utilize the data. For example, data pertaining to the state of valve 30 may be presented to a user, for example, as a percentage corresponding with the general amount that valve 30 is open, according to the following relationship:

$$P e r c e n t a g {e}_{Valve Open} = \frac{{V}_{C u r r e n t}}{{V}_{Max}} \times 100 .$$

where V_{curr} is a current velocity of the material 12 and Vₘₐₓ is a maximum velocity of the material 12. This equation assumes the minimum velocity is zero, which is the case when the valve 30 is closed, or when a downstream valve is closed. If there is a circulation system or similar device which maintains a minimum velocity above zero, the equation can be modified to subtract that minimum velocity from the Vₘₐₓ.

In accordance with some embodiments, the state of valve 30 may be presented to a user, for example, via one or more visual interface devices 80. For example, visual interface devices 80 may be or otherwise may include one or more lights, which may include a solid-state light source, such as a light-emitting diode (LED), or any other device capable of emitting light of a given wavelength, optionally with a given emission period or pattern. In one example, the visual interface device 80 is a strip of a plurality of lights positioned on or proximate to the at least one valve, wherein the state of the at least one valve is indicated by a quantity of the plurality of lights within the strip that are illuminated. In another example, the visual interface device 80 includes two lights having different colors than one another, wherein the state of the at least one valve is indicated by a color of light illuminated by one or both of the two lights.

For instance, in more detail, the visual interface device 80 may be configured to emit light of a first color (e.g., red light) and/or emit light of a different second color (e.g., green light). In another example case, a single visual interface device 80 may be configured to emit multiple colors, such as the first and second colors previously noted. A given visual interface device 80 may be configured to output optical output signal(s) indicative of a given condition with respect to valve 30. For instance, in some cases, the visual interface device 80 may be configured to emit light indicative of any one or a combination of valve 30 states, such as an open valve, a closed valve, and a leaking valve. In some cases, the visual interface device 80 may be disposed proximate valve 30, a control device for the valve 30, within a control room 76, within an interface accessible through an electronic network, or elsewhere.

It is also noted that a Doppler-based approach additionally, or alternatively, may be utilized in determining the state of a valve 30 associated with a vessel 20.

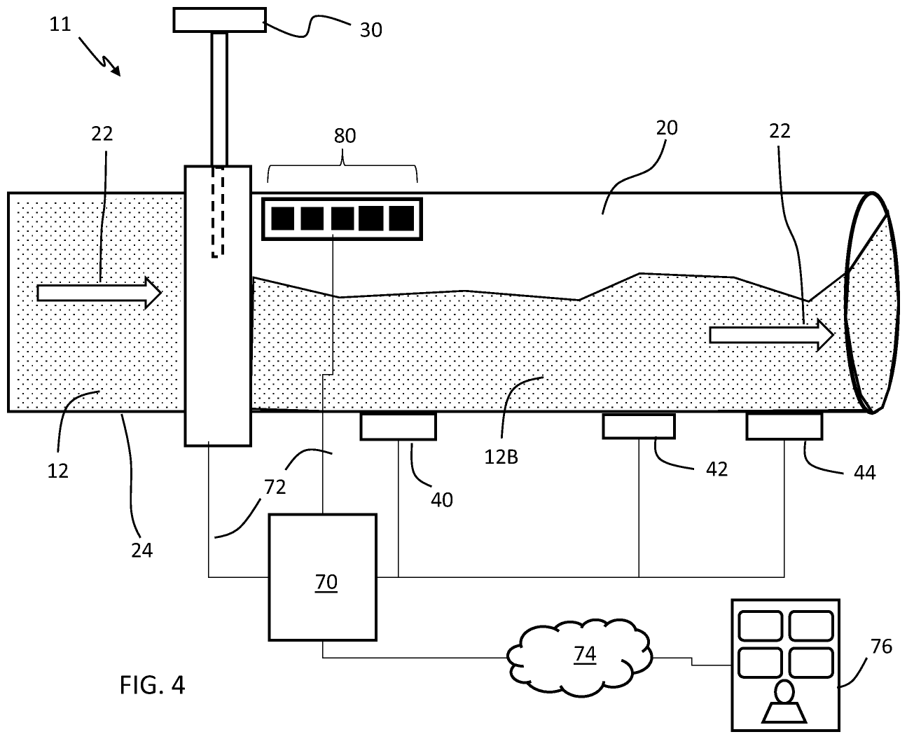

The subject disclosure may also be used to determine the presence of a material within a vessel, which is described relative to FIGS. 2-4. FIG. 2 is a diagrammatical illustration of a system 11 for determining the presence of a material in a vessel 20, in accordance with the first exemplary embodiment of the present disclosure. FIGS. 3-4 are diagrammatical illustrations of the system for determining the presence of a material in a vessel of FIG. 2, in accordance with the first exemplary embodiment of the present disclosure. For clarity in disclosure, components described relative to FIG. 1 are depicted in FIGS. 2-4 with the same reference characters and have the same description as provided relative to FIG. 1.

With reference to FIGS. 2-4 together, the presence of a material 12 in a vessel 20 can be determined using an acoustic sensor 44, which can be used, if desired, to provide a determined state of the valve 30. As can be seen in FIG. 2, the material 12 is present upstream of valve 30, where the flow direction 22 of the material 12 is towards the valve 30. The valve 30 is in a closed state, such that the material 12 is prevented from moving downstream of valve 30, which results in a substantially empty space 14 within the vessel 20. It is noted that the substantially empty space 14 may still have some material 12 therein but is considered to be substantially free of material 12 for clarity in disclosure. An acoustic sensor 44 may be disposed proximate the exterior surface 24 of vessel 20, downstream of valve 30. More specifically, acoustic sensor 44 may be mounted directly or indirectly, e.g., with one or more intervening layers, to the exterior surface 24 of vessel 20. In at least some such cases, acoustic sensor 44 may be disposed proximate the bottom, e.g., the gravitationally downward side or portion, of vessel 20.

The output of acoustic sensor 44 may be provided to one or more processing devices or computing devices, as described relative to FIG. 1. From the information so received, the processor of the computer device 70 may calculate the density in a localized region of vessel 20. The density calculation generally may be indicative of the presence or absence of a material in a given region of vessel 20. For instance, a measured density differing from an expected density value may be indicative of the presence of a material in vessel 20, whereas a measured density substantially equal to an expected density value may be indicative of the absence of a material in vessel 20. The density information may be used in determining whether material 12 is present in vessel 20 currently or after an upstream valve 30 has been opened or closed, e.g., as may be useful in detecting a leaky valve 30.

In further detail, FIG. 3 illustrates a situation where the valve 30 is intended to be fully closed such that the flow of material 12 from upstream the valve 30 is prevented from reaching the portion of the vessel 20 downstream of the valve 30. However, due to a malfunction of the valve 30, a small amount 12A of the material 12 is able to pass through the valve 30 and reaches the portion of the vessel 20 which should have a substantially empty space 14. In this situation, the acoustic sensor 44 may detect the density of the small amount 12A of the material 12, which can be used to indicate that the valve 30 is not fully closed. This information, in turn, can be used to transmit an alert of the state of the valve, automatically close the valve, e.g., by transmitting a control signal to an actuator in mechanical communication with the valve, or perform another action.

FIG. 4 illustrates a situation where the valve 30 is intended to be fully opened such that the flow of material 12 from upstream the valve 30 should be able to move past the valve 30 unimpeded. However, due to a malfunction of the valve 30, only a portion 12B of the material 12 is able to pass through the valve 30 and reach a downstream position within the vessel 20. In this situation, the acoustic sensor 44 may detect the density of the portion 12B of the material 12, but the first and second acoustic sensors 40, 42 may detect a flow rate which is at a lower amount than expected, as described relative to FIG. 1. The combination of signals from these sensors 40, 42, and 44 may be used to indicate that the valve 30 is not fully opened, thereby limiting the flow rate through the vessel 20. This information, in turn, can be used to transmit an alert of the state of the valve, automatically open the valve, or perform another action.

It is noted that the processor of the computer device 70 may be configured to output one or more signals including data indicative of the presence or absence of material 12 within vessel 20 or the state of the valve 30, all of which are considered within the subject disclosure. The description provided relative to FIG. 1 with respect to the output signals, communication devices, display devices, and storage devices apply equally in the context of FIG. 2. Similarly, the description provided relative to FIG. 1 with respect to presenting visual indications via one or more visual interface devices 80 may apply equally in the context of FIGS. 2-4. A visual interface device 80 may be configured, to output optical output signal(s) indicative of a given condition with respect to the presence or absence of a material in vessel 20 or a state of the valve 30. In some cases, a visual interface device 80 may be disposed proximate valve 30 or a control means for the valve 30.

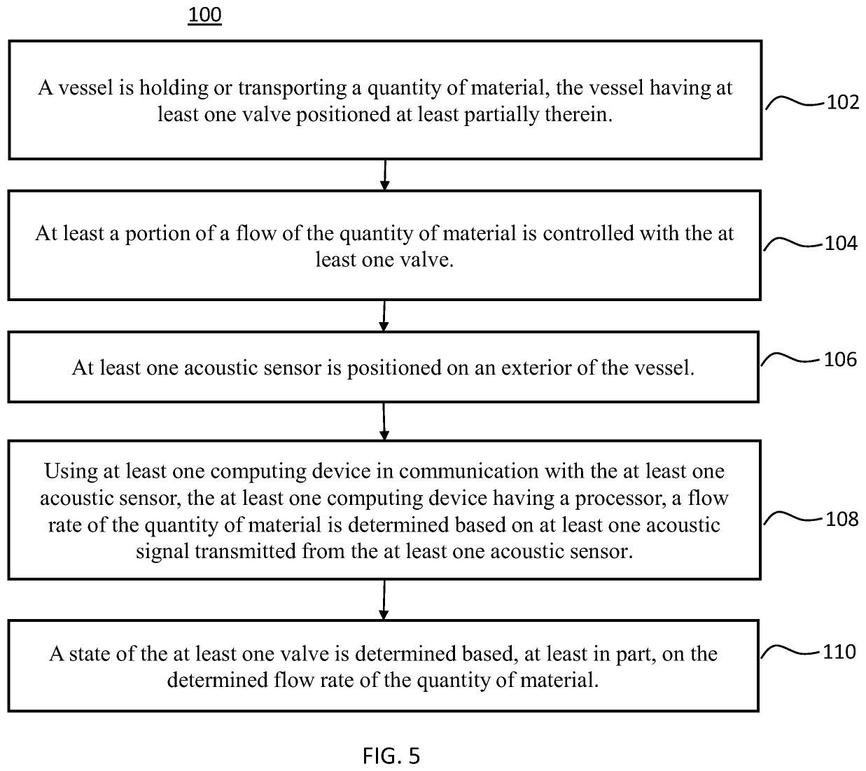

FIG. 5 is a flowchart 100 illustrating a method of determining the state of a valve within a vessel, in accordance with the first exemplary embodiment of the present disclosure. It should be noted that any process descriptions or blocks in flow charts should be understood as representing modules, segments, portions of code, or steps that include one or more instructions for implementing specific logical functions in the process, and alternate implementations are included within the scope of the present disclosure in which functions may be executed out of order from that shown or discussed, including substantially concurrently or in reverse order, depending on the functionality involved, as would be understood by those reasonably skilled in the art of the present disclosure.

As is shown by block 102, a vessel is holding or transporting a quantity of material, the vessel having at least one valve positioned at least partially therein. At least a portion of a flow of the quantity of material is controlled with the at least one valve (block 104). At least one acoustic sensor is positioned on an exterior of the vessel (block 106). Using at least one computing device in communication with the at least one acoustic sensor, the at least one computing device having a processor, a flow rate of the quantity of material is determined based on at least one acoustic signal transmitted from the at least one acoustic sensor (block 108). A state of the at least one valve is determined based, at least in part, on the determined flow rate of the quantity of material (block 110). Any number of additional steps, functions, processes, or variants thereof may be included in the method, including any disclosed relative to any other figure of this disclosure.

In at least some cases, use of techniques described herein may provide benefit to any of a wide range of parties, including workers, site owners, and valve manufacturers, to name a few. In at least some cases, use of techniques described herein may reduce the amount of work required to operate, maintain, and/or replace a valve at a given site. In at least some cases, use of techniques described herein may improve workplace safety. For instance, techniques disclosed herein may be helpful, for example, in at least some cases where a vessel needs to be opened and a hazardous material is inside. As will be appreciated, knowing whether a vessel, in fact, is empty may improve safety. Also, as will be appreciated, knowing that no material spillage will occur may reduce unnecessary workload for cleanup.

It should be emphasized that the above-described embodiments of the present disclosure, particularly, any “preferred” embodiments, are merely possible examples of implementations, merely set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and the present disclosure and protected by the following claims.

What is claimed is:

1. A system for determining a valve state comprising:
a vessel holding or transporting a quantity of material;
at least one valve positioned within the vessel, the at least one valve controlling at least a portion of a flow of the quantity of material;
at least one acoustic sensor positioned on an exterior of the vessel; and
at least one computing device in communication with the at least one acoustic sensor, wherein a processor of the at least one computing device determines a flow rate of the quantity of material based on at least one acoustic signal transmitted from the at least one acoustic sensor, and wherein the processor determines a state of the at least one valve based, at least in part, on the determined flow rate of the quantity of material.

2. The system of claim 1, wherein the state of the valve is one or more of: an open state, a closed state, a partially open state, or a partially closed state.

3. The system of claim 1, wherein the determined state of the at least one valve further comprises a percentage open of the at least one valve.

4. The system of claim 3, wherein the percentage open of the at least one valve is calculated using an equation:
$$P e r c e n t a g {e}_{Valve Open} = \frac{{V}_{C u r r e n t}}{{V}_{Max}} \times 100$$
where, V_{curr} is a current velocity of the quantity of material and Vₘₐₓ is a maximum velocity of the quantity of material.

5. The system of claim 1, further comprising at least one visual interface visually displaying an indication of the state of the at least one valve.

6. The system of claim 5, wherein the visual interface further comprises a strip of a plurality of lights positioned proximate to the at least one valve, wherein the state of the at least one valve is indicated by a quantity of the plurality of lights within the strip that are illuminated.

7. The system of claim 5, wherein the visual interface further comprises at least two lights having different colors than one another, wherein the state of the at least one valve is indicated by a color of light illuminated by one or more of the at least two lights.

8. The system of claim 1, wherein the at least one acoustic sensor further comprises at least two acoustic sensors positioned a determined distance from one another on the vessel, wherein a differential time-of-flight measurement is used to determine the flow rate of the quantity of material.

9. The system of claim 1, wherein the at least one acoustic sensor determines a density of the material within the vessel.

10. A system for determining a presence of a material within a vessel comprising:
a vessel capable of holding or transporting a quantity of material;
at least one valve positioned within the vessel, the at least one valve controlling at least a portion of a flow of the quantity of material;
at least one acoustic sensor positioned on an exterior of the vessel at a position on an underside of the vessel; and
at least one computing device in communication with the at least one acoustic sensor, wherein a processor of the at least one computing device determines a density of any material positioned within the vessel in a location above the at least one acoustic sensor, and wherein the processor determines a presence of material within the vessel based on, at least in part, the determined density of the quantity of material.

11. The system of claim 10, wherein the processor determines a state of the at least one valve based, at least in part, on the determined presence of the quantity of material.

12. A method of determining a valve state comprising:
providing a vessel holding or transporting a quantity of material, the vessel having at least one valve positioned at least partially therein;
controlling at least a portion of a flow of the quantity of material with the at least one valve;
positioning at least one acoustic sensor on an exterior of the vessel;
using at least one computing device in communication with the at least one acoustic sensor, the at least one computing device having a processor, determining a flow rate of the quantity of material based on at least one acoustic signal transmitted from the at least one acoustic sensor; and
determining a state of the at least one valve based, at least in part, on the determined flow rate of the quantity of material.

13. The method of claim 12, wherein determining the state of the valve further comprises determining one or more of: an open state, a closed state, a partially open state, or a partially closed state.

14. The method of claim 12, wherein determining the state of the at least one valve further comprises determining a percentage open of the at least one valve.

15. The system of claim 14, further comprising calculating the percentage open of the at least one valve using an equation:
$$P e r c e n t a g {e}_{Valve Open} = \frac{{V}_{C u r r e n t}}{{V}_{Max}} \times 100$$
where, V_{curr} is a current velocity of the quantity of material and Vₘₐₓ is a maximum velocity of the quantity of material.

16. The method of claim 12, further comprising visually displaying an indication of the state of the at least one valve with at least one visual interface.

17. The method of claim 16, wherein the visual interface further comprises a strip of a plurality of lights positioned proximate to the at least one valve, wherein the state of the at least one valve is indicated by a quantity of the plurality of lights within the strip that are illuminated.

18. The method of claim 16, wherein the visual interface further comprises at least two lights having different colors than one another, wherein the state of the at least one valve is indicated by a color of light illuminated by one or more of the at least two lights.

19. The method of claim 12, wherein the at least one acoustic sensor further comprises at least two acoustic sensors positioned a determined distance from one another on the vessel, further comprising determining the flow rate of the quantity of material with a differential time-of-flight measurement between the at least two acoustic sensors.

20. The method of claim 12, further comprising determining a density of the material within the vessel with the at least one acoustic sensor.
